(19) United States
(12) Patent Application Publication
(10) Pub. No.: US 2015/0345736 A1
(43) Pub. Date: Dec. 3, 2015

(54) Cinema Light with LED Modules and Interchangeable Lenses

(71) Applicant: Marcelo L. Colacilli, Canyon Country, CA (US)

(72) Inventor: Marcelo L. Colacilli, Canyon Country, CA (US)

(21) Appl. No.: 14/723,376

(22) Filed: May 27, 2015

Related U.S. Application Data
(60) Provisional application No. 62/005,519, filed on May 30, 2014.

(51) Int. Cl. F21V 5/00; F21K 99/00; F21V 17/10; F21V 17/02; F21V 29/76; F21V 5/04

(52) U.S. Cl. CPC F21V 5/007; F21V 29/763; F21V 5/048; F21V 17/105; F21V 17/02; F21K 9/30; F21Y 2105/001

(57) ABSTRACT

A scalable design for an LED based cinema light suitable for use in the movie, television, and video industries, among others, is presented. The LED light of the present invention includes a plurality of LED modules arranged in square or rectangular frames or cases. The output of the LED light can be scaled up or down to accommodate any particular need by varying the number of LED modules and types of LEDs used in the light. Each individual LED module features a linear array of LEDs mounted on a base plate, corresponding heat sinks mounted on a back side of the base plate, and a corresponding protective lenses mounted over the LEDs on a front side of the base plate. The LED light of the present invention also features removable lens plate assemblies of focusing lens, wherein the light output of each LED is focused by a corresponding focusing lens.

### CROSS REFERENCE TO RELATED APPLICATIONS

This application claims priority to U.S. Provisional Application Ser. No. 62/005,519, filed on May 30, 2014, the contents of which are expressly incorporated herein by reference in their entirety.

### BACKGROUND OF THE INVENTION

1. Field of the Invention

The present invention relates generally to high output lights for use principally in the motion picture, television and video industries, and, more particularly, to a design for a high output LED based light suitable for set lighting.

2. Background of the Invention

Lighting systems are an integral part of the motion picture, television, and video industries. Proper illumination is necessary when filming motion pictures, television shows, music videos and the like, regardless of whether such activities take place indoors or outdoors.

Prior art cinema lights typically comprise incandescent, tungsten-halogen or xenon lamp bulbs enclosed within a metal housing which typically includes an assembly for holding the bulb or bulbs, a reflector and a focusing lens. Prior art cinema lights of this type of construction work well and have been developed to provide a beam of projected light of relatively uniform intensity across the entire area of the projected beam. Nevertheless, prior art cinema lights have several drawbacks. In particular, the lights are energy inefficient and generate substantial heat.

Prior art cinema lamps are notably energy inefficient because in prior art lamps, most of the light generated by the typical omnidirectional incandescent, tungsten-halogen or xenon bulbs, actually strikes and is absorbed by the interior of the housing. Relatively little of the total light generated is directed or reflected forward to serve as useful light. This inefficiency in light projection is compounded by the general inefficiency of incandescent, tungsten-halogen or xenon light bulbs.

The other major drawback of prior art cinema lights is very high heat production. Due to the heat generated, care must be taken regarding the placement of the lighting fixtures and the manner in which they are handled. The heat generated by prior art cinema lamps also effects the duration of time for which they can be used, as excessive heat production effects bulb life. The heat produced by prior art cinema lamps may also create other drawbacks such as limiting how close subjects can approach the lamps and causing localized distortions in the ambient air which may cause optical distortions apparent on the filmed or recorded image. Color changes in light output may also occur due to the effect of heat aging of the bulb or bulbs.

In recent years, lights using pluralities of light-emitting diodes or “LEDs” have gained in popularity in applications such as streetlights and outdoor area lights. Now LED based lights are beginning to find application in the movie, television and video production industries. LED based lights have certain advantages over conventional lamps, namely they are relatively bright, relatively energy efficient, have a long life and a consistent color temperature, and while LED lamps generate substantial heat, it is nevertheless less than that generated by prior art cinema lights using incandescent, tungsten-halogen or xenon bulbs.

The art of LED lamp design, particularly for cinema lighting, is relatively new. At the present time such lights are just beginning to be introduced to the film and television industries and no particular design has proven to be superior and the industry has yet to settle on a standardized design. Many issues related to how best to design LED based lights for use in the film, television and video production industries have yet to be adequately resolved, leaving room for improvement in the art.

It is the purpose of the present invention to provide a design for an LED based lamp suitable for stage lighting in the movie, television and video production industries.

### SUMMARY OF THE INVENTION

The LED cinema light of the present invention presents a scalable design for an LED based cinema light suitable for use in the movie, television, and video production industries, as well as for use in any application where general area lighting is desired. The present invention LED cinema light addresses many of the design issues faced in developing high output area lights for general area lighting applications, as well as movie, television and video applications.

The present invention LED cinema light includes a plurality of LED modules arranged in square and rectangular frames or cases. The output of the LED cinema light can be scaled up or down to accommodate any particular need by varying the number and length of the LED modules used in the light, as well as the power handling capability of the individual LEDs used in the modules.

In each LED module, the individual LEDs are mounted as a linear array on a front surface of a base plate, which in the exemplary embodiment is a generally elongated, rectangular aluminum extrusion, upon which a plurality of individual LEDs and associated wiring are attached by means of electrically insulative epoxy. Placed over each individual LED in an LED module, and embedded in the epoxy, is a clear, protective lens, which in the exemplary embodiment is plano-convex dome shaped lens, which both protects the LED and focuses the emitted light. The heat produced by each individual LED is conducted from the LED and dissipated to the atmosphere by means of a heat sink attached behind the LED on a backside of the base plate of the LED module. In alternative embodiments, the heat sink may be fabricated as part of the base plate, i.e. the base plate and heat sink may be a unitary component.

The LED modules are mounted in the frame or case such that there is a longitudinal air gap between each adjacent LED module and a similar longitudinal air gap between end LED modules and the frame or case. The longitudinal air gaps assist in dissipating the heat generated by the LEDs by allowing air flow past the LED modules through the gaps. The cooling effect contributed by the air gaps is believed to be most significant when the LED Cinema light of the present invention is pointed either straight up or straight down.

The light produced by each individual LED is also focused by an associated focusing lens, which in the exemplary embodiment, is a refractive lens, centered over each LED and associated protective lens. The individual focusing lenses are mounted to lens plate assemblies in a linear array, where one focusing lens corresponds to one LED in an LED module. Thus, for each LED module in the LED cinema light of the present invention, there is a corresponding lens plate assembly of focusing lenses.

In the exemplary embodiment of the present invention, each lens plate assembly is removably attachable to the case of the LED cinema light. In alternative embodiments, each lens plates may be removably attached directly to an LED module. In the exemplary embodiment, magnets are used as the means of attachment. The removably attachable lens plate assemblies allow for a variety of lighting effects to be achieved with the same LED cinema light by swapping out the lens plate assemblies for other lens plate assemblies having different optical properties. This feature of the LED cinema light of the present invention is particularly desirable in the movie, television and video production industries where it is often desirable to produce light with a variety of different characteristics.

The above and other features of the invention will become more apparent from the following detailed description.

### BRIEF DESCRIPTION OF THE DRAWINGS

FIG. 1 is a schematic front perspective view of an exemplary embodiment of the LED cinema light of the present invention.

FIG. 2 is a schematic sectional view, taken along the line 2-2 of FIG. 1, with the lens plate assemblies removed, showing the arrangement of the component parts of the LED modules of the LED cinema light of FIG. 1.

FIG. 3 is an enlarged schematic detail view of the area of circle 3 of FIG. 1, showing the arrangement of the component parts of the LED modules of the LED cinema light of FIG. 1.

FIG. 4 is a schematic front detail view of an LED module of the LED cinema light of FIG. 1.

FIG. 5 is a schematic sectional view, taken along the line 2-2 of FIG. 1, showing the relationship between an LED module and a lens plate assembly of the LED cinema light of FIG. 1.

FIG. 6 is a schematic side view a removable lens plate assembly of the LED cinema light of FIG. 1.

FIG. 7 is a schematic front view of a removable lens plate assembly of the LED cinema light of FIG. 1.

FIG. 8 is a schematic view showing the relationship between an LED and a protective lens and a focusing lens, in accordance with the LED cinema light of the present invention.

### DETAILED DESCRIPTION OF THE PREFERRED EMBODIMENTS

The present invention will now be described more fully hereinafter with reference to the accompanying drawings, in which preferred embodiments of the invention are shown. The invention may, however, may be embodied in many different forms and should not be construed as being limited to the embodiments set forth herein. Rather these embodiments are provided so that this disclosure will be thorough and complete, and will fully convey the scope of the invention to those skilled in the art. Like numbers refer to like elements throughout.

The term “light emitting diode” or “LED” refers to a particular class of semiconductor devices that emit visible light when electric current passes through them. The term light emitting electro-chemical cell” or “LEC” refers to any of a class of light emitting optoelectronic devices comprising a polymer blend embedded between two electrodes, which emit light in response to an electrical current. The term “artificial light source” or “ALS” refers to any controllable artificial luminescent device, including LEDs and LECs, and any other type of electrically controllable artificial light source.

The term “plurality” as used in the specification and claims herein is to be interpreted as being coextensive with and inclusive of the term “at least one.”

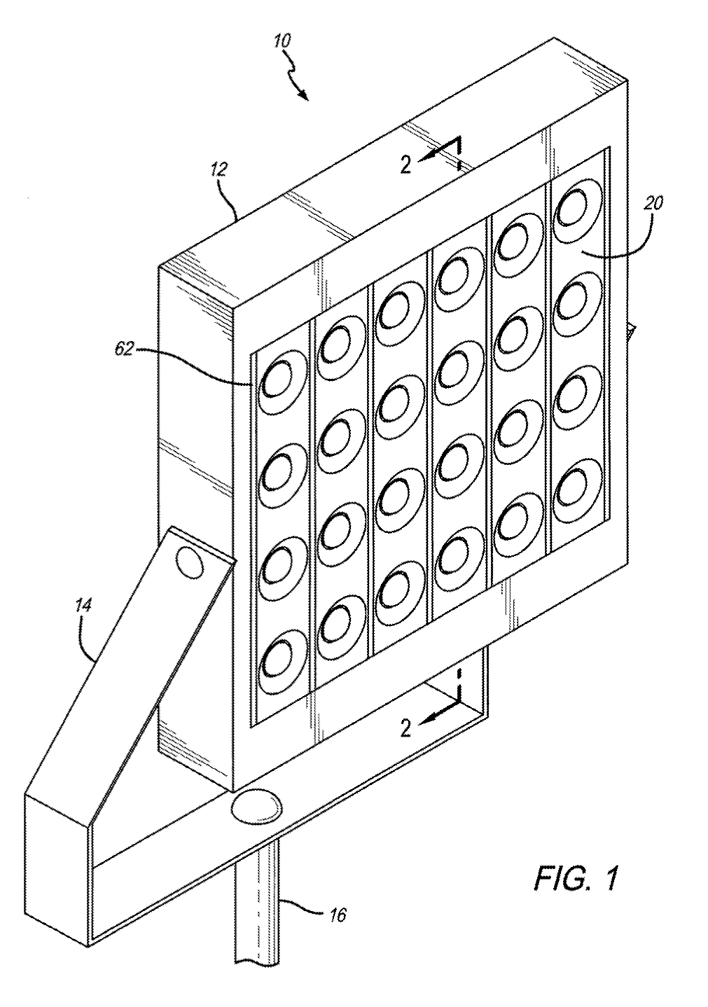

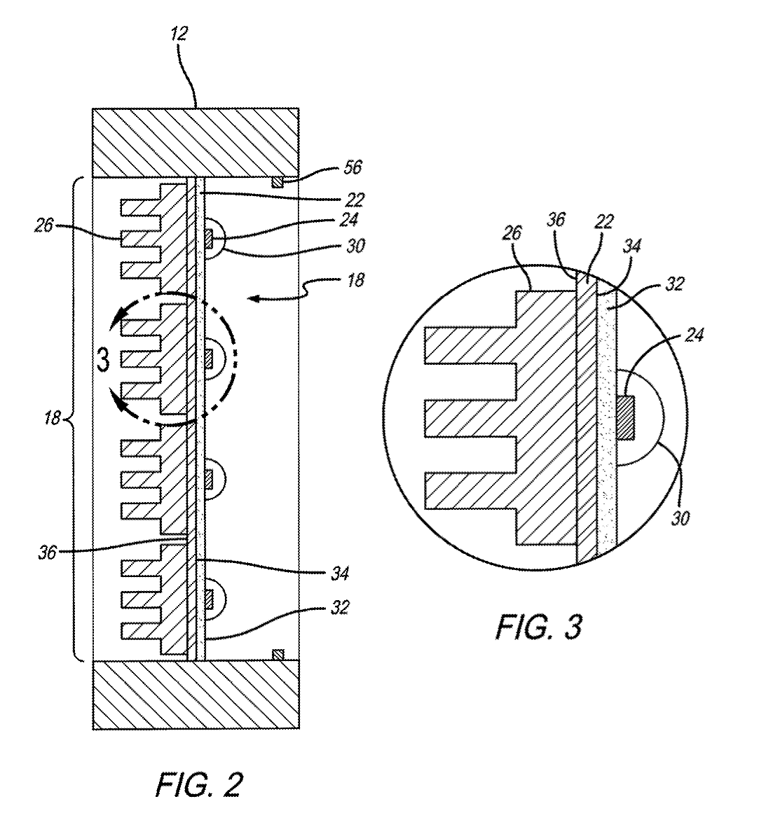

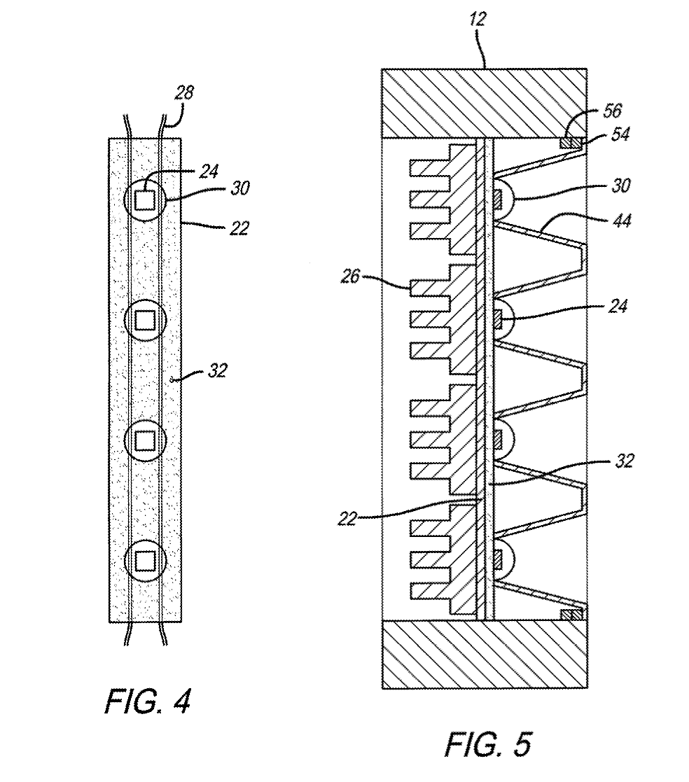

With reference to FIGS. 1 through 7, an LED cinema light 10 in accordance with the present invention is shown. The LED cinema light 10 generally comprises a plurality of LED modules 18 and a plurality of interchangeable or removable lens plate assemblies 20, which are mounted in a case 12. Each LED module 18 includes a plurality of LEDs 24 and each tens plate assembly 20 includes a plurality of focusing lenses 44, wherein each focusing lens 44 of a lens plate assembly 20 corresponds to one LED 24 of an LED module 18. The light produced by each individual LED 24 is focused and shaped by one of the corresponding focusing lenses 44, as well as by one of a plurality of corresponding protective lenses 30.

With reference to FIG. 1, the LED cinema light 10 will typically include a mounting bracket 14 which pivotally attaches to the case 12 and pivotally attaches to a vertical light support 16. This mounting arrangement provides the LED cinema light 10 with an adjustable field of illumination about two axes of rotation, i.e. the LED cinema light 10 may be rotated about a transverse axis corresponding to the pivotal attachment of the bracket 14 to the frame or case 12 and may also be rotated about a longitudinal axis corresponding to that of the vertical light support 16. The vertical light support 16, typically a tripod style support, also allows for vertical height adjustment of the LED cinema light 10.

With reference to FIGS. 1 through 7, each LED module 18 includes a base plate 22, a plurality of the LEDs 24, a plurality of heat sinks 26, and a plurality of the protective lenses 30. The base plate 22 is generally an elongated, rectangular aluminum extrusion. The base plate 22 has a front side 34 and a back side 36. Attached to the front side 34 of the base plate 22 are a plurality of the LEDs 24 arranged as a linear array. The LEDs 24 and associated wiring 28 are attached to the front side 34 of the base plate 22 by means of a layer of insulative epoxy 32.

Attached to the back side 36 of the base plate 22 are a plurality of the heat sinks 26. (In alternative embodiments, the base plate 22 and heat sink 26 may be fabricated as a single component.) For each LED 24, there is one corresponding heat sink 26 which is mounted on the backside 36 of the base plate 22, directly behind its corresponding LED 24. On the front side 34 of the base plate 22, attached over each individual LED 24 is one of the protective lenses 30. The protective lenses 30 are secured to the front side 34 of the base plate 22 by means of the layer of insulative epoxy 32.

With reference to FIG. 1, the LED modules 18 are mounted in the frame or case 12 such that there is a longitudinal air gap 62 between each adjacent LED module 18 and a similar longitudinal air gap 62 between the LED modules 18 positioned adjacent to vertical members of the frame or case 12. The longitudinal air gaps 62 assist in dissipating the heat generated by the LEDs 24 by allowing air flow past the LED modules 16 through the air gaps 62. The cooling effect contributed by the longitudinal air gaps 62 is believed to be most significant when the LED Cinema light 10 of the present invention is pointed either straight up or straight down.

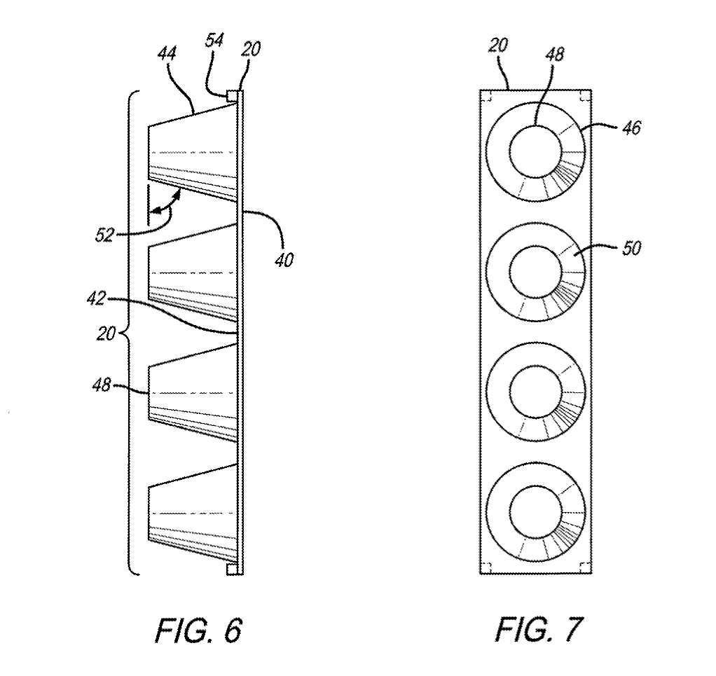

With reference to FIGS. 5-8, each of the interchangeable lens plate assemblies 20 of the present invention LED cinema lamp 10 comprises a lens holding plate 38 having a front side 40 and a back side 42 and a plurality of holes or openings 46 wherein one of focusing lenses 44 is mounted in each of the holes 46. The focusing lenses 44 are generally conical, refractive lenses and have an aperture 48, an exit 50, and a taper angle 52 (see FIG. 6). The taper angle 52 may vary within the range of about 5 degrees to about 90 degrees, depending upon the lighting effect desired. In commercial embodiments, a variety of lenses with taper angles between 5 degrees and 90 degrees, in 5 or 10 degree increments are expected to be provided.

In the LED cinema lamp of the present invention 10, for each LED 24 of each of the LED modules 18, there is the corresponding focusing lens 44 mounted on one of the corresponding lens plate assemblies 20. The case 12 is configured such that the LED modules 18 are secured within the case and above each of the LED modules 18 is mounted one of the plurality of lens plate assemblies 20. The lens plate assemblies 20 are configured such that one of the apertures 48 of each of the focusing lenses 44 is positioned about and just above one of the protective lenses 30 which covers each LED 24. A desirable feature of the LED Light 10 of the present invention is that the lens plate assemblies 20 are quickly and easily removable from the case 12. The ability to quickly remove and replace the lens plate assemblies 20 with other lens plate assemblies having focusing lenses of different optical characteristics provides a cinematographer with the ability to tailor the quality of the light emitted by the LEDs 24 to the needs of any particular scene. In the exemplary embodiment, the lens plate assemblies 20 are removably attachable to the frame or case 12. In alternative embodiments, the lens plate assemblies may be removably attached directly to the LED modules 18.

In the exemplary embodiment of the LED cinema lamp 10, the lens plate assemblies 20 include magnets 54, mounted at each corner of the backside 42 of the lens holding plate 38. The magnets 54 of the lens plate 20 are configured to mate with ferromagnetic regions 56 located on the frame or case 12. The ferromagnetic regions 56 may also be magnets. The use of magnets to attach the lens plate assemblies 20 to the case 12 of the LED lamp 10 of the present invention is just one way in which the lens plate assemblies 20 may be removably coupled to the case. A person of skill in the art will understand that other quick release fasteners and mechanisms could be substituted for the magnets 54 and ferromagnetic regions 56.

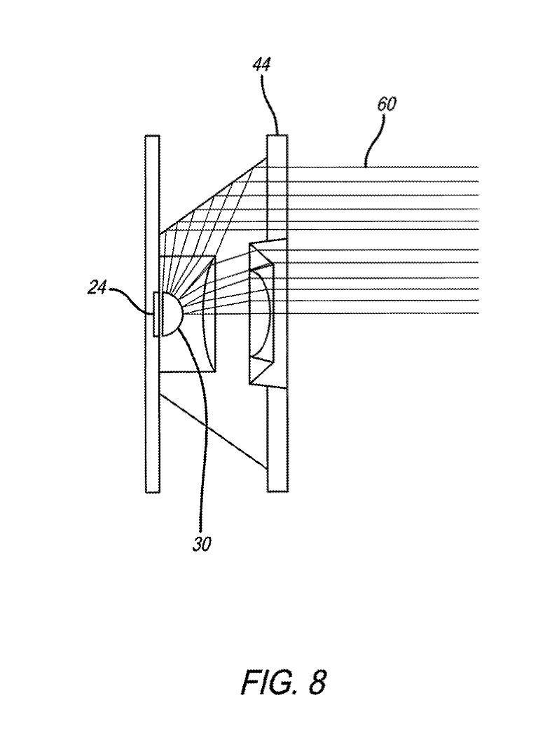

With reference to FIG. 8, the relationship between each LED 24 and corresponding protective lens 30 and focusing lens 44 is shown in more detail. As shown in FIG. 8, light rays 60 emitted from the LED are focused into a generally circular beam by the combined action of the protective lenses 30 and focusing lenses 44. By changing the optical characteristics of the focusing lenses 44, a variety of lighting conditions can be produced.

Not shown, but included with each LED cinema light are LED driver electronics required to operate the LEDs. Suitable electronics are commercially available and are known to those of skill in the art.

In the exemplary embodiment, the case 12 of the LED light 10 is made from aluminum extrusions. Other materials, including molded plastic materials and formed sheet metal, are also suitable. The size of the case 12 is determined by the length of the LED modules 18 and the width of the case is determined by the number of LED modules 18 to be used in the case. The length and width of the LED modules 18 and that of the case 12 will vary depending upon the desired output wattage and intended purpose of the light.

The configuration of the LED cinema lamp 10 of the present invention is flexible and can readily be scaled up or down to meet the needs of any particular task. In the exemplary embodiment of the LED cinema lamp 10 shown in FIG. 1, the LED modules 18 and corresponding lens plate assemblies 20 are shown in a vertical arrangement comprising vertical columns of LED modules 18 and lens plate assemblies 20. It will be appreciated that the LED modules 18 and lens plate assemblies 20 may also be arranged in horizontal rows. Other arrangements are also possible.

In the exemplary embodiment, the base plates 22 of the LED modules 18 are made from extruded aluminum. Aluminum is lightweight and has good thermal conductivity which renders is a good material choice for the base plates 22 which must have good heat conduction properties. Other nonferrous, as well as ferrous, metallic materials are also suitable. In the exemplary embodiment, the lens holding plates 38 of the lens plate assemblies 20 are also made from aluminum. Other materials which can withstand the heat output of the LEDs, including most metallic materials are also suitable. Some heat resistant plastic materials may also be suitable. The protective lenses 30 and focusing lenses 44 may be made from clear or translucent materials including glass and many plastics.

In the exemplary embodiment, of the LED cinema light 10, the protective lenses 30 are plano-convex lenses. However, other lens types such as plano-concave lenses are also suitable. In some alternative embodiments, the protective lenses 30 may also be clear or translucent protective covers which lack focusing properties. Likewise, in the exemplary embodiment of the LED cinema light 10, the focusing lenses 44 are conical, refractive lenses. However, other lens types are also suitable such as Fresnel lenses. The focusing lenses 44 may be of variety of optical configurations to produce a variety of lighting characteristics.

Suitable LEDs 24 for use in the present invention are commercially available and are known to those of skill in the art. In alternative embodiments, LECs or other artificial light sources may be substituted for the LEDs 24.

The foregoing detailed description and appended drawings are intended as a description of the presently preferred embodiment of the invention and are not intended to represent the only forms in which the present invention may be constructed and/or utilized. Those skilled in the art will understand that modifications and alternative embodiments of the present invention which do not depart from the spirit and scope of the foregoing specification and drawings, and of the claims appended below are possible and practical. It is intended that the claims cover all such modifications and alternative embodiments.

1. An ALS cinema light, comprising:
a plurality of ALS modules, each ALS module including a base plate having a front side and a back side, wherein a plurality of ALSs, linearly arranged are attached to the front side of the base plate and a plurality of heat sinks, one for each ALS, are attached to the back side of the base plate;
a plurality of lens plate assemblies, each lens plate assembly corresponding to one of the plurality of ALS modules, wherein each lens plate assembly contains a plurality of focusing lenses, each focusing lens corresponding to one ALS of the plurality of ALSs on the corresponding ALS module; and
a case, the case including provisions for mounting each of the plurality of ALS modules and each of the plurality of corresponding lens plate assemblies, wherein the lens plate assemblies are removably mounted to the case in a position in front of the ALS modules.

2. The ALS cinema light of claim 1, wherein each of the plurality of ALS modules further includes a protective lens mounted over each of the plurality of ALSs.

3. The ALS cinema light of claim 2, wherein the protective lens mounted over each of the plurality of LEDs is a plano-convex lens.

4. The ALS cinema light of claim 1, wherein each of the plurality of focusing lenses contained on the plurality of lens plate assemblies is a refractive lens.

5. The ALS cinema light of claim 4, wherein each refractive lens is a generally conical lens having a taper angle within the range of about 5 degrees to about 90 degrees.

6. The ALS cinema light of claim 1, wherein each of the plurality of lens plate assemblies is removably mounted to the case via magnets attached to the lens plates and mating ferromagnetic regions on the case.

7. An ALS light, comprising:
a plurality of ALS modules, each ALS module including a plurality of ALSs, linearly arranged;
a plurality of lens plate assemblies, each lens plate assembly corresponding to one of the plurality of ALS modules, wherein each lens plate assembly contains a plurality of focusing lenses, each focusing lens corresponding to one ALS of the plurality of ALSs on the corresponding ALS module; and
a case, the case including provisions for mounting each of the plurality of ALS modules and each of the plurality of corresponding lens plate assemblies, wherein the lens plate assemblies are removably mounted to the case in a position in front of the ALS modules.

8. The ALS light of claim 7, wherein each ALS module of the plurality of ALS modules further includes a plurality of heat sinks, each heat sink being thermally coupled to one of the plurality of ALSs.

9. The ALS light of claim 8, wherein each ALS of each ALS module is thermally coupled to one of the plurality of heat sinks by a base plate composed of a thermally conductive material.

10. The ALS light of claim 7, wherein each of the plurality of ALS modules further includes a protective lens mounted over each of the plurality of ALSs.

11. The ALS light of claim 10, wherein the protective lens mounted over each of the plurality of ALSs is a plano-convex lens.

12. The ALS light of claim 7, wherein each of the plurality of focusing lenses contained on the plurality of lens plates is a refractive lens.

13. The ALS light of claim 13, wherein each refractive lens is a generally conical lens having a taper angle within the range of about 5 degrees to about 90 degrees.

14. The ALS light of claim 13, wherein each of the plurality of lens plate assemblies is removably mounted to the case via magnets attached to the lens plates and mating ferromagnetic regions on the case.

15. An ALS area light, comprising:
at least one ALS module, the at least one ALS module including a plurality of ALSs;
at least one lens plate assembly, the at least one lens plate assembly containing a plurality of focusing lenses, each focusing lens corresponding to one of the plurality of ALSs on the at least one ALS module;
wherein light incident from each ALS is focused by each corresponding focusing lens; and
wherein the at least one lens plate assembly is removably mounted to the at least one ALS module.

16. The ALS area light of claim 15, wherein each focusing lens is a refractive lens.

17. The ALS area light of claim 16, wherein each refractive lens is a generally conical lens having a taper angle within the range of about 5 degrees to about 90 degrees.

18. The ALS area light of claim 15, wherein each ALS of the plurality of ALSs further includes a protective lens mounted over each of the ALSs.

19. The ALS area light of claim 15, wherein the protective lens mounted over each ALS of the plurality of ALSs is a plano-convex lens.

20. The ALS area light of claim 15, wherein the lens plate assembly is removably mounted to the case via magnets attached to the lens plates and mating ferromagnetic regions on the case.
